(19) United States
(12) Patent Application Publication
(10) Pub. No.: US 2004/0218544 A1
(43) Pub. Date: Nov. 4, 2004

(54) Router capable of displaying network system

(76) Inventor: Ray Lee, Taipei (TW)

Correspondence Address: Ray Lee, P.O. Box 4-67, Hsin Chuang, Taipei, 242, TW

(21) Appl. No.: 10/429,507

(22) Filed: May 2, 2003

(51) Int. Cl. H04L 12/56

(52) U.S. Cl. 370/252

(57) ABSTRACT

A router device includes a router integrated circuit coupled to a processor device, one or more couplers for coupling to network systems or end users, a display for information displaying purposes, and a detecting circuit to detect various information of the end users or of the network systems. The router device may be used to detect and display various information, such as the number of the end users, the signals transmitting speeds, the internet protocol (IP), the addresses, the communication protocol, the information of the intrusion of the hackers, or other information, for allowing the users to easily take suitable actions.

### BACKGROUND OF THE INVENTION

1. Field of the Invention

The present invention relates to a router facility, and more particularly to a router facility capable of displaying the communication status or information of network system.

2. Description of the Prior Art

Typical router facilities may comprise a number of ports or couplers for coupling to a number of end users simultaneously, and are provided for allowing the end users to communicate with each other, and/or to communicate with various network systems, such as ethernet network systems, local area network (LAN) systems, wireless local area network (WLAN) systems, etc.

The end users that are simultaneously coupled to the typical router facility may communicate with each other and may share the information from the network systems.

However, when the end users are going to know the communication status or the communication with the network systems, such as the number of the end users, the signals transmitting speeds, the internet protocol (IP), the addresses, the communication protocol, the information of the intrusion of the hackers, etc., a number of additional man powers, and displaying facilities, and programs, and the like are required to be provided to detect or to value or to show the number of the end users, the signals transmitting speeds, the internet protocol (IP), the addresses, the communication protocol, the information of the intrusion of the hackers, etc

In addition, it takes a lot of time to detect or to value or to show the number of the end users, the signals transmitting speeds, the internet protocol (IP), the addresses, the communication protocol, the information of the intrusion of the hackers, etc

The present invention has arisen to mitigate and/or obviate the afore-described disadvantages of the conventional router facilities.

### SUMMARY OF THE INVENTION

The primary objective of the present invention is to provide a router facility capable of detecting and displaying the number of the end users, the signals transmitting speeds, the internet protocol (IP), the addresses, the communication protocol, the information of the intrusion of the hackers, or other information, for allowing the users to easily take suitable actions.

In accordance with one aspect of the invention, there is provided a router facility comprising a router device including a processor device, a router integrated circuit coupled to the processor device, at least one coupler for coupling to network systems, a display coupled to the processor device for information displaying purposes, and a detecting circuit for detecting various information, the display being provided to display the information detected by the detecting circuit.

The router device includes at least one memory coupled to the processor device, to store information detected by the detecting circuit. The router device includes at least one second coupler for coupling to end users. The router device includes at least one memory coupled to the processor device, to store information of the end users.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan schematic view of a router facility in accordance with the present invention;

FIG. 2 is a block diagram of a router device of the router facility; and

FIG. 3 is a block diagram illustrating the operation of the router facility.

### DETAILED DESCRIPTION OF THE PREFERRED EMBODIMENT

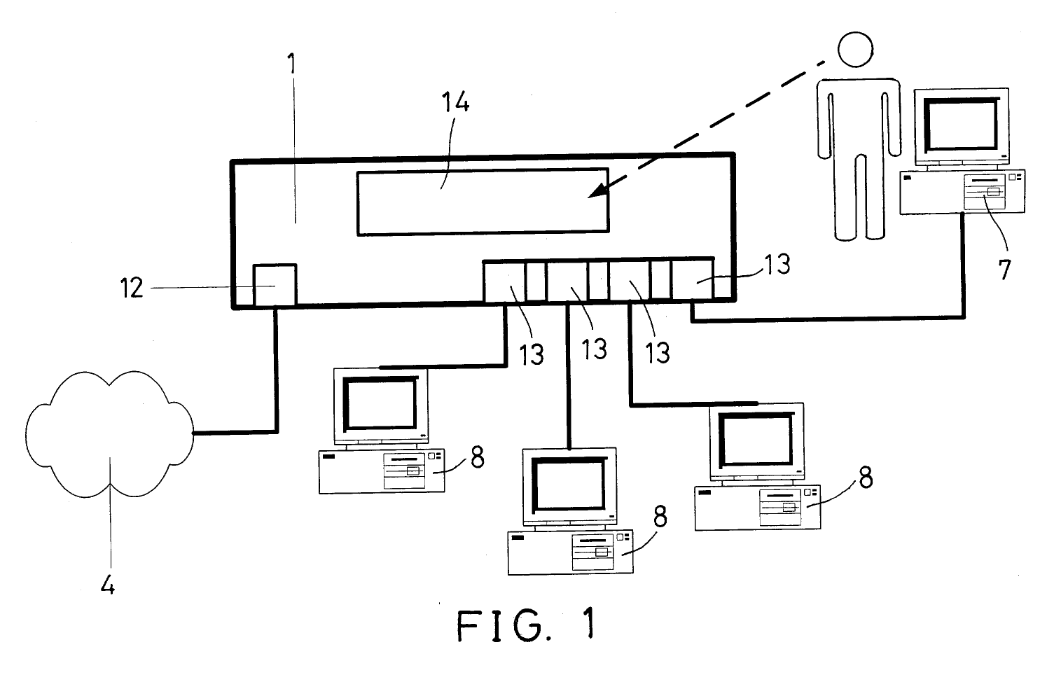

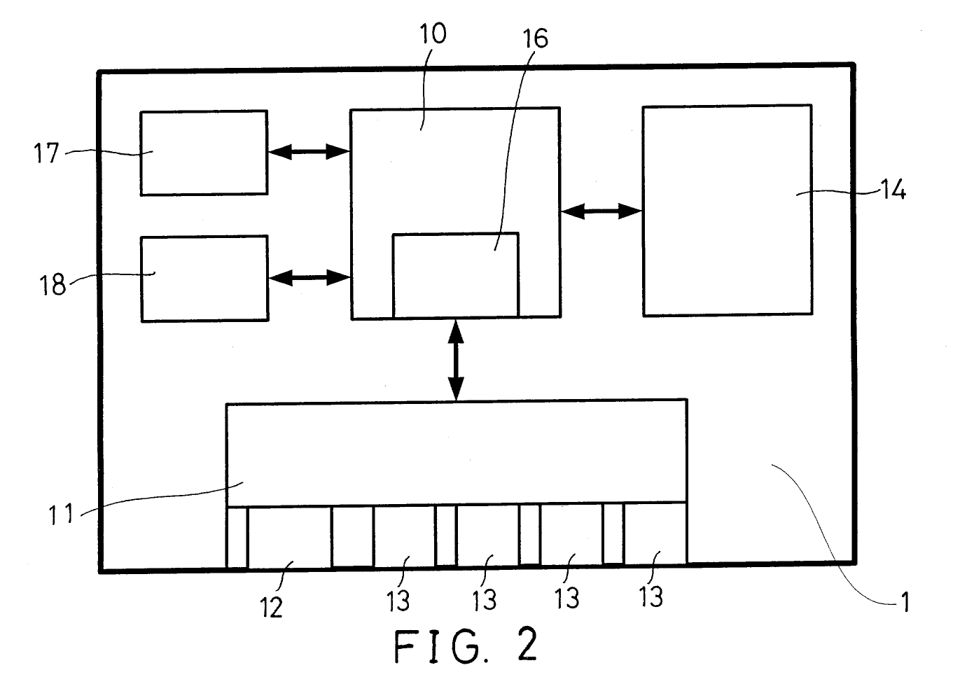

Referring to the drawings, and initially to FIGS. 1 and 2, a router facility in accordance with the present invention comprises a router device 1 including a microprocessor or central processor unit or processor device 10, for receiving and processing various information or data or the like, and including a router chip or integrated circuit 11 coupled to the processor device 10 for telecommunication purposes or for receiving and routing or detecting various information or data or the like.

The router device 1 includes one or more ports or couplers 12 for coupling to various network systems 4, such as ethernet network systems, local area network (LAN) systems, wireless local area network (WLAN) systems, etc.; and further includes one or more ports or couplers 13 for coupling to one or more end users 7, 8 simultaneously, and thus for allowing the end users 7, 8 to communicate with each other, and/or to communicate with or to share the various network systems 4.

A display 14, such as a liquid crystal display (LCD) or the like, is provided and coupled to the processor device 10, to display various data or information or images.

The processor device 10 includes a detecting circuit 16, or a detecting circuit 16 is provided and coupled to the processor device 10, to detect various information, such as the number of the end users, the signals transmitting speeds, the internet protocol (IP), the addresses, the communication protocol, the information of the intrusion of the hackers, or other information.

The detected numbers of the end users, signals transmitting speeds, internet protocol (IP), addresses, communication protocol, information of the intrusion of the hackers, or other information may then be sent to the processor device 10, and/or may then be shown in the display 14. The workers or the users may then easily know the detected numbers of the end users, signals transmitting speeds, internet protocol (IP), addresses, communication protocol, information of the intrusion of the hackers, or other information, and may then take suitable action according to the detected information.

One or more memories 17, 18, such as one or more flash memories 17 and one or more synchronous dynamic access memories 18 may further be provided and coupled to the processor device 10, for storing the identifications, the data or information of the end users 7, 8, for example, and/or for storing the data or information from the detecting circuit 16.

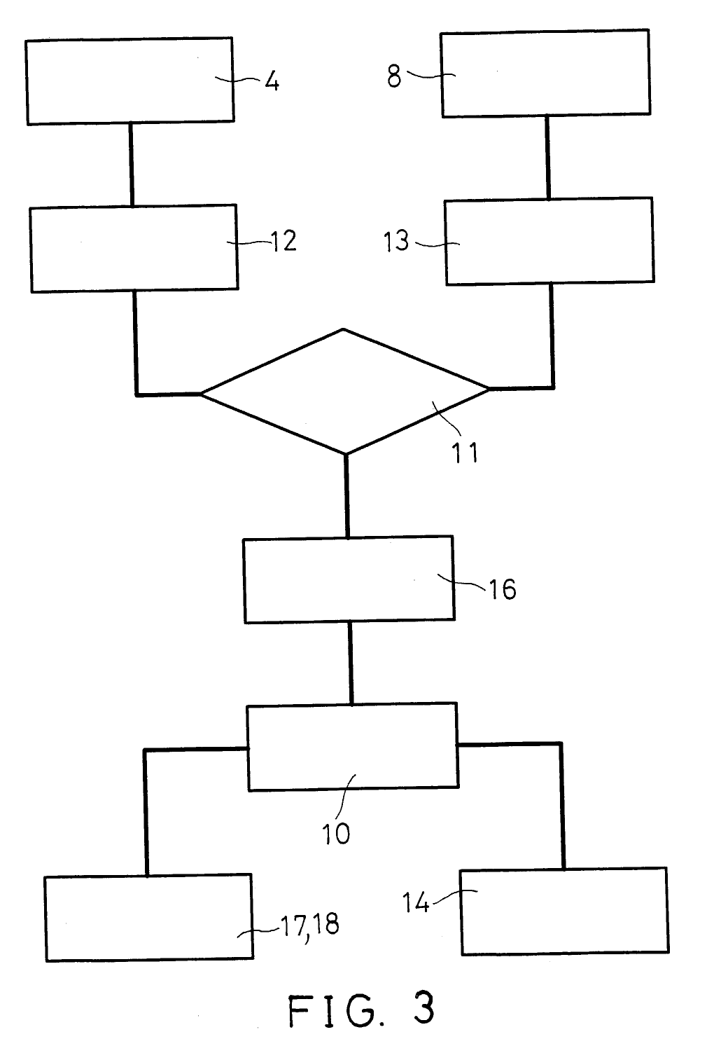

In operation, as shown in FIGS. 1-3, the end users 7, 8 may be coupled or connected to various network systems 4 via the couplers 12. The router integrated circuit 11 may then receive and detect the package or information where from, and/or the destinations thereof, and may then send the information to the processor device 10, and/or to the other end users 7, 8.

The detecting circuit 16 may then detect various information, such as the number of the end users, the signals transmitting speeds, the internet protocol (IP), the addresses, the communication protocol, the information of the intrusion of the hackers, or other information, which may then be sent to the processor device 10, and/or may then be shown in the display 14. The workers or the users may then easily know the detected numbers of the end users, signals transmitting speeds, internet protocol (IP), addresses, communication protocol, information of the intrusion of the hackers, or other information, and may then take suitable action according to the detected information.

The detected numbers of the end users, signals transmitting speeds, internet protocol (IP), addresses, communication protocol, information of the intrusion of the hackers, or other information may be sent to the processor device 10, and/or may be processed by the processor device 10, and/or sent to and displayed in the display 14, and/or sent to and stored in such as the synchronous dynamic access memories 18.

The workers or the end users 7, 8 may then easily overcome or fix or recover the detected problems, or may take actions against the hackers, etc., according to the information stored in such as the synchronous dynamic access memories 18, and/or displayed in the display 14, without additional man powers, and displaying facilities, and programs, and the like.

Accordingly, the router facility in accordance with the present invention is capable of detecting and displaying the number of the end users, the signals transmitting speeds, the internet protocol (IP), the addresses, the communication protocol, the information of the intrusion of the hackers, or other information, for allowing the users to easily take suitable actions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A router facility comprising a router device including a processor device, a router integrated circuit coupled to said processor device, at least one coupler for coupling to network systems, a display coupled to said processor device for information displaying purposes, and a detecting circuit for detecting various information, said display being provided to display the information detected by said detecting circuit.

2. The router facility as claimed in claim 1, wherein said router device includes at least one memory coupled to said processor device, to store information detected by said detecting circuit.

3. The router facility as claimed in claim 1, wherein said router device includes at least one second coupler for coupling to end users.

4. The router facility as claimed in claim 1, wherein said router device includes at least one memory coupled to said processor device, to store information of the end users.
